(19) United States
(12) Patent Application Publication
(10) Pub. No.: US 2021/0035013 A1
(43) Pub. Date: Feb. 4, 2021

(54) REFINED USER ENABLEMENT UTILIZING REINFORCED LEARNING

(71) Applicant: International Business Machines Corporation, Armonk, NY (US)

(72) Inventors: Nihar Tiku, Gurgaon (IN); Prashanth K. Kayampady, Bangalore (IN)

(21) Appl. No.: 16/527,260

(22) Filed: Jul. 31, 2019

(51) Int. Cl. G06N 20/00; G06F 16/2457

(52) U.S. Cl. CPC G06N 20/00; G09B 5/00; G06F 16/24578

(57) ABSTRACT

A processor may receive profile data associated with a user. The processor may identify, from the profile data, a degree of proficiency of the user. The degree of proficiency may indicate an ability of the user to relay specific information to a second user. The processor may designate the degree of proficiency as a first level. The processor may generate a proposal to increase the first level to a second level. The increase may indicate an increase in the degree of proficiency. The processor may display the proposal to the user.

### BACKGROUND

The present disclosure relates generally to the field of machine learning, and more specifically to automatically utilizing reinforced learning techniques to generate a refined, tailored proposal for a user.

Throughout the world there are numerous institutions (e.g., learning institutions, business institutions, governmental institutions, etc.) and each institution has their own set of rules, regulations, and practices. Due to the numerous instances of different institutions each having their own practices, it has become increasing difficult for educators in the institutions to educate others of their institutions evolving practices and/or unit the institutions in a common practice.

### SUMMARY

Embodiments of the present disclosure include a method, computer program product, and system for automatically utilizing reinforced learning techniques to refine user enablement. A processor may receive profile data associated with a user. The processor may identify, from the profile data, a degree of proficiency of the user. The degree of proficiency may indicate an ability of the user to relay specific information to a second user. The processor may designate the degree of proficiency as a first level. The processor may generate a proposal to increase the first level to a second level. The increase may indicate an increase in the degree of proficiency. The processor may display the proposal to the user.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example system for generating a proposal to display to a user, in accordance with embodiments of the present disclosure.

FIG. 2 illustrates a table that indicates the inputs and actions to transpire at each phase of the reinforced learning, in accordance with embodiments of the present disclosure.

FIG. 3 illustrates a flowchart of an example method for generating a proposal to display to a user, in accordance with embodiments of the present disclosure.

FIG. 4 depicts a cloud computing environment, in accordance with embodiments of the present disclosure.

FIG. 5 depicts abstraction model layers, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of machine learning, and more specifically to automatically utilizing reinforced learning techniques to generate a refined, tailored proposal for a user. While the present disclosure is not necessarily limited to such applications, various aspects of the disclosure may be appreciated through a discussion of various examples using this context.

Many of the current solutions for educator enablement are typically based on processes driven by the institution for which the educator works. The processes are, typically, further dependent on the availability of such an opportunity to implement the processes, the willingness of the educator to implement the processes, and the state of the art (e.g., materials, reference materials, etc.) available for such processes (e.g., initiatives, activities, etc.) to take place at a location. Such hurdles for implementing processes not only delay the enablement process (e.g., the education/training of others by the educator), but also undermine a development need that should be a continuously on-going process based on current needs of not only the individuals being educate, but also the (education) processes in question.

At a district, zone, or state level, such enablement processes are dependent on a number of factors that are not controlled or driven by the actual institutional needs, but through systemic prioritization of the institution and the individuals of the institution. Accordingly, there is a need for a refined, tailored approach for each individual (e.g., educator, student, manager, etc.) who implements an institution's processes that will ensure that there is homogeneity in the overall educator enablement. Thereby making the outcomes of an educator's training of others more predictable and/or controllable with respect to the overall quality of the implemented processes.

Accordingly, in some embodiments, a processor may receive profile data associated with a user (e.g. educator, manager, trainer, etc.). The processor may identify, from the profile data, a degree of proficiency of the user. The degree of proficiency may indicate an ability of the user to relay specific information to a second user. The processor may designate the degree of proficiency as a first level. The processor may generate a proposal to increase the first level to a second level. The increase may indicate an increase in the degree of proficiency. The processor may display the proposal to the user.

For example, a kindergarten teacher may have a teacher profile that indicates that the teacher has bachelor's degree in primary education, 5 years of teaching primary grade children, and has a preferred method of teaching: visual (e.g., the teacher likes to teach the children using visual prompts such as picture books, etc.). The teacher's profile may be submitted (e.g., either by the teacher or the teacher's employer) to a reinforced learning system. The system may analyze the teacher's profile and determine from the profile that the teacher has, on a scale of 1 to 10, an 8 degree proficiency for teaching kindergarten.

The system may determine the degree of proficiency for the teacher is an 8 by identifying that most kindergarten teachers need a bachelor's degree in teaching and the most efficient kindergarten teachers have over 3 years of experience. However, the system may also identify that the most efficient kindergarten teachers use a kinematic method to learning. In this example, the system may use a degree of proficiency scale that does not add points to a scale, but subtracts from 10 any missing or undesirable skills, e.g., the teacher lost 2 points for having a visual teaching style. Other embodiments of the degree of proficiency scale are envisioned however and the example provided above is not limiting. For instance, a scale that adds points for each positive skill is envisioned and a scale that uses weights for preferred skills is also envisioned (e.g., years of teaching experience could have a higher point value than a teacher having a teaching degree, etc.)

Continuing the example, the system may designate the degree of proficiency: 8 as a first level, indicating that the teacher needs to advance two levels (e.g., level 8 to 9 and level 9 to 10) to have mastery in her current teaching environment. The system may then use a reinforced learning model to identify which steps the teacher should likely take to improve their teaching to progress the two levels to have a degree of proficiency of 10. For instance, the system may generate a proposal that indicates that the teacher should first take a course in kinematic learning to progress one level, and then do summer school for one year to advance the second level.

In some embodiments, the degree of proficiency is measured on a scale and the scale may include qualitative factors and quantitative factors set by an outside entity. For example, a store manager may have a performance evaluation by their general manager and the general manager may provide the performance evaluation to a system that will provide useful instructions to help the store manager be more efficient. The performance evaluation may include the general managers general comments (e.g., qualitative factors) about the store managers performance (e.g., great attitude, friendly, etc.) and the statistics (e.g., quantitative factors) of how the store is doing (e.g., backstock inventory, sales, etc.). The system may then analyze the comments and statistics and provide, on a scale of 0 to 100, how well the store manager is managing their store.

In some embodiments, the processor may analyze the profile data in regard to the qualitative factors and quantitative factors. The processor may identify a number of qualitative factors and quantitative factors that appear in the profile data. Following the example above, in order to determine/identify the degree of proficiency, the system may look at a prepopulated guideline reference (e.g., the stores training manual, etc.). The system may then compare the manual with the store manager's profile and determine if the store manager reaches general proficiency guidelines (e.g., the manual indicates that a store manager should have a basic understanding of logistics and the store manager's resume indicates that they have taken advanced classes in statistics, then the system will increase the store manager's degree of proficiency.)

In some embodiments, when generating the (selected) proposal, the processor may generate one or more proposals. The processor may identify a degree of success for each of the one or more proposals. The processor may rank, based on the degree of success, the one or more proposals. The processor may identify that the (selected) proposal is ranked above each of the other proposals.

For example, a processor may be evaluating a current course of action to allow a mechanical engineer to transfer to a position of a software engineer. The processor may identify that to be a software engineer a candidate should have experience in more than one coding language. The processor may then identify that the mechanical engineer is versed in C++, however they lack skills in other coding languages. The processor may then generate a first course of action that says that the mechanical engineer should learn Python™ first and the processor may generate a second course of action that says that the mechanical engineer should learn JAVA™ first.

The processor may then analyze each coding language (e.g., from reviews by other software engineers, computer science majors, etc.) and determine that Python™ is subjectively harder to learn compared to JAVA™. The processor may then rank the course of action to learn JAVA™ first above the course of action to learn Python™ first. The processor may then select and display the JAVA™ course of action to the mechanical engineer as the proposed course of action to take if they want to more easily learn the skills to be a software engineer.

In some embodiments, identifying the degree of success for each of the one or more proposals may include the processor weighting each of the one or more proposals based on the profile data and the degree of proficiency. The processor may determine, from the weighting, which of the one or more proposals increase the first level to the second level.

For example, in order to tailor proposals for individual users, the processor may take into account the personal traits of the user, as identifiable from the profile data. The profile data may indicate that a physical education teacher prefers hand-eye sports such as tennis and that the physical education teacher usually skimps on cardio sports such as long-distance running. The processor may determine that on a percentage scale, the physical education teacher has a 50% proficiency score because they rarely teach their pupils proper running techniques that will lessen impact on their knees and hips. The processor may determine that 50% proficiency equates to the physical education teacher being at an intermediate level (e.g., a first level as determined to comparative physical education teachers, comparative professionals in the physical education field at the same 50% proficiency, etc.).

The processor may then generate a proposal that indicates the physical education teacher should start having their pupils run one day a week and another proposal that indicates the physical education teacher should have their pupils play lacrosse one day a week in order to increase the pupils cardio activity. Additionally, each proposal could raise the physical education teacher's degree of proficiency to 75% proficiency, which could in turn amount to an increase to an advanced level (e.g., a second level) for the physical education teacher. The processor may take into account the physical education teacher's affinity for hand-eye sports and weight the lacrosse proposal above the running proposal as lacrosse incorporates running on a field as well as hand-eye coordination activities. The processor may then suggest the lacrosse activity to the physical education teacher.

In some embodiments, the processor may weight each of the one or more proposals with historical data. The historical data may be associated with one or more users that are identified as having a shared trait with the user. The shared trait may be identified from the profile data. The processor may select the proposal to display to the user. The proposal may be selected for being a personalized match for the user. Following the example above, the processor may have identified 100 other physical education teachers that prefer hand-eye sports and the processor may have proposed lacrosse curriculums to 20 of the physical education teachers before proposing lacrosse to the physical education teacher introduced above.

The processor may identify that of the 20 that were previously suggested a lacrosse curriculum that 15 physical education teachers had success in advancing to an advanced level or more (e.g., an expert level, a third level, etc.), with the curriculum, which is a 75% success rate (i.e., 15/20=0.75). The processor may then weight the lacrosse proposal for the above-mentioned physical education teacher even further above the running proposal as there is a history of successfully advancing physical education teachers to higher levels.

In some embodiments, the processor may receive an addendum set of profile data associated with the user. The addendum may indicate if the first level increased to the second level. The processor may utilize the addendum to refine the one or more proposals. The processor may display a second proposal to the user. For example, a user may be sent an interactive prompt asking the user to rank their experience with the proposal and if the proposal provided an avenue that allowed the user to increase the degree of proficiency and/or rank/level in a particular field. If the user indicates that they did not feel that they learned anything or did not feel like they were better off after following the proposal they may indicate as such and the processor will use the interactive prompt as an input to generate a new proposal for the user. The processor will further use the interactive prompt to weight down the original proposal as to make sure that the processor does not repeat the same, failed proposal to the user.

In some embodiments, the processor will continue to provide an interactive prompt to a user after each proposal. This will continue to refine the proposals for the user and subsequent users in the same fields (e.g., career, schooling, etc.). It is noted that the use of the interactive prompts to refine proposals is indicative of a feedback loop and machine learning, where the processor continues to provide better proposals (e.g., solutions, outputs, outcomes, etc.) the more the processor can process a query (e.g., determining the best course of action to allow a user to increase their proficiency and levels in a field, etc.).

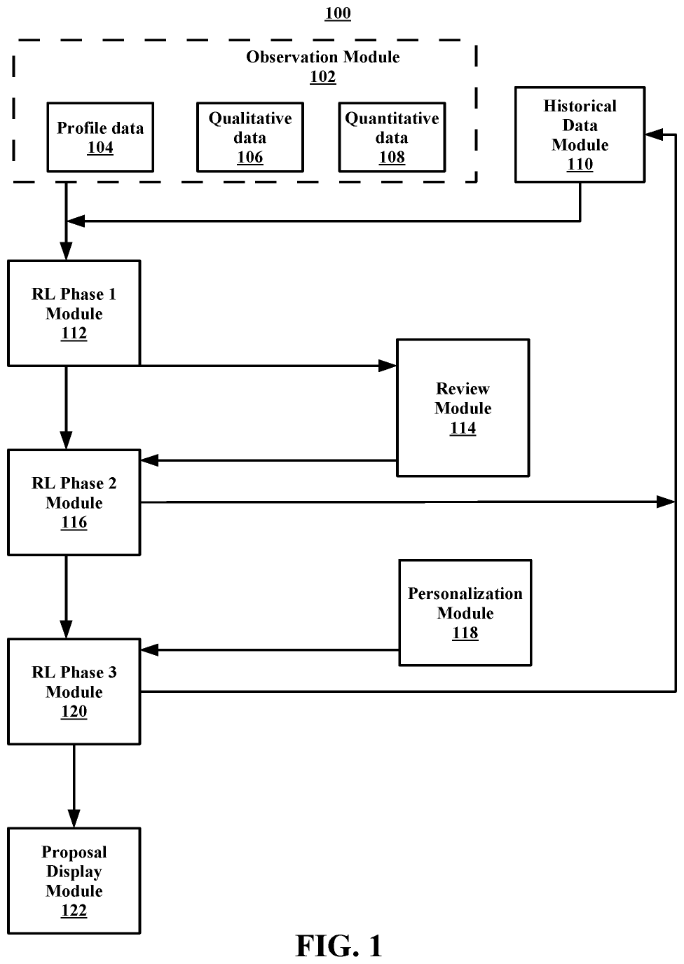

Referring now to FIG. 1, illustrated is an example system 100 for generating a proposal to display to a user, in accordance with embodiments of the present disclosure. In some embodiments, the system 100 includes an observation module 102, a historical data module 110, a reinforced learning (RL) phase 1 module 112, a review module 114, an RL phase 2 module 116, a personalization module 118, an RL phase 3 module 120, and a proposal display module 122. In some embodiments, the observation module 102 includes profile data 104, qualitative data 106, and quantitative data 108.

In some embodiments, the system 100 works as a reinforced learning based system, which uses computation techniques of successive, as well as, transitive evaluation of all observations captured by the system 100 (e.g., from the observation module 102, and in some embodiments, the historical data module 110). Analysis of the profile data 104, qualitative data 106, and quantitative data 108 of the observation module 102, in addition to historical data (not shown) of the historical data module 110 leads to a recommendation/reward at each RL phase 1-3 module 112, 116, and 120. Each recommendation/reward at each RL phase 1-3 module 112, 116, and 120 in turn becomes part of the observation for the subsequent phase (e.g., the output of the RL phase 1 Module 112 is an input/observation for the RL phase 2 module 116, and the output of the RL phase 2 module 116 is an input/observation for the RL phase 3 module 120) to arrive at the final recommendation/reward. Where the final recommendation/reward is a set of personalized & prioritized recommendation(s)/proposal(s) for the user's (e.g., educator's, manager's, trainer's, etc.) enablement that is displayed to the user via the proposal display module 122.

In Phase 1 (not shown) of the RL phase 1 module 112, the system 100 captures all the data related to the user's ability, as an observation. In some embodiments, the data related to the user's ability would be from various sources like the profile data 104, the qualitative data 106, and the quantitative data 108, which can be used to determine a baseline (e.g., first level, degree of proficiency, etc.) and which can include data like current academic level, preferences, secondary area of interest etc. In some embodiments, the data may further include a recording of the user during an active training/teaching session that was conducted by the user (e.g., a quantitative and qualitative record by identifying/counting from the recording how many pupils/other users were actively engaged with the user during the training). In some embodiments, if the user is an educator (e.g., teacher, professor, etc.) the data further can include classroom results as a measurement of effectiveness (e.g., overall pass percentage, classification of results by grade-segments, etc.), as well as periodic formal review of the educator by a subject matter expert (SME) panel.

In some embodiments, based on the observations, the system 100 can run a custom computation to determine the weight as well as the overall relevance of each observation (e.g., from the data) in Phase Ito find the strengths and/or areas of improvement for the user in question. The computation can be based on qualitative (e.g., self-feedback, SME panel feedback, qualitative data pointes, etc.) as well as quantitative (e.g., results, survey, metrics, etc.) data points.

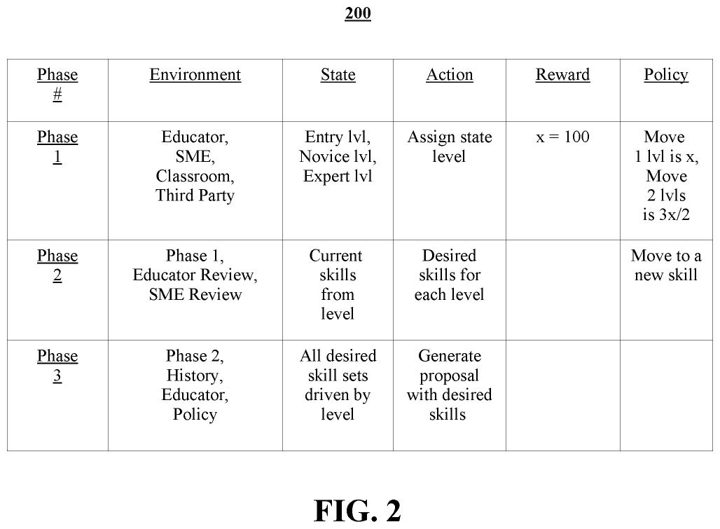

In Phase 2 (not shown) of the RL phase 2 module 116, the recommendations of Phase 1 can be the key observation(s)/input(s) along with other sources such as, but not limited to, historical data from the historical data module 110, and a user review and final moderation/review by an SME Panel from the review module 114, which can allow a user/panel to review the observations presented from Phase 1 before they are analyzed by the RL phase 2 module 116 at Phase 2. Again, it is noted that the computation in Phase 2 can use a custom and configurable model (which is discussed more fully in regard to FIG. 2 below) to determine a final set of recommendations/rewards, which will highlight the area of improvement, or the opportunity, for the user to augment their skill base.

In Phase 3 (not shown) of the RL phase 3 module 120, the system 100 can pick the recommendations from Phase 2 as key observations/inputs followed by the history of such recommendations as provided by the historical data module 110. In some embodiments, in addition to the observations provided from the RL phase 2 module 116 and the historical data module 110, observations can also be utilized from the personalization module 118. The personalization module 118 can take into account the active interest area(s) of the user, requirements of the institution/region where the user works, the alignment the institution/region has with the interest area(s) expressed by the user and the area of expertise of the user. Using the set of these observations, the system 100 can provide a set of prioritized recommendations/proposals to the user via the proposal display module 122. In some embodiments, the recommendations/proposals can be actionable by the user as well as the authority associated with the system 100 (e.g., the user's managing institution, boss, etc.), that is, the proposals can be selected by either the user or the system 100 and then displayed to the user for use and implementation to help with their enablement of a subject.

It is noted that in terms of Reinforced Learning (RL) that a final set of recommendation(s)/proposal(s) for enablement can be described as a set based on all the data (e.g., profile data 104, qualitative data 106, quantitative data 108, data included from the review module 114 and data included from the personalization module 118), including historical data from the historical data module 110. In some embodiments, this can mean the user is displayed, via the proposal display module 122, a list with recommendation(s)/proposal(s) for obtaining formal higher education, attending a short term specialized course, attending an on-line course, attending a workshop based augmentation, or obtaining certifications in some type of training/management. Again, it is noted that this would be driven by the observations/inputs coming in from the environment of such a system 100.

In some embodiments, for such a system 100, the rules of operation are invariably known and can be used to sequentially deduce the final state (e.g., as described above in regard to deducing a proposal form Phases 1, 2, and 3). In some embodiments, the system 100 may implement the Exploration and Exploitation rule, that is, the system 100 can learn from known rules and subsequent state data, such that each successive recommendation will be backed by a more accurate statement of a policy that is then used for the computation at/during a Phase.

Referring now to FIG. 2, illustrated is a table 200 that indicates the inputs and actions to transpire at each phase of the reinforced learning, in accordance with embodiments of the present disclosure. In some embodiments, the table 200 indicates the inputs and actions to transpire as a result of a computer-implemented method (not shown in FIG. 2). In some embodiments, the table 200 indicates which phase, environment, state, action, reward, and/or policy can be implemented during the flow of the computer-implemented method.

In some embodiments, the computer-implemented method can use Q-Learning and/or reinforced learning. In such an embodiment, a skill set could be a configurable set for a given level of expertise (e.g., a degree of proficiency, level, etc.); values or the actual list for the level of expertise could constitute mandatory competencies (e.g., qualitative and quantitative factors) and could be decided or published at the entity or institution level (e.g., a job posting listing necessary requirements for applying for the job, etc.); and a value of gamma (e.g., a weighting value, numeric, weight, etc.) will keep evolving as the computer-implemented method starts to churn more recommendations.

In regard to the table 200 that utilizes the discussed computer-implemented method to generated the information at each phase 1, 2, and 3; a generic Q-function for the three phases is contemplated:

Q(state, action)=R(state, action)+Gamma*Max[Q(next state, all actions)]

The value of Gamma can be tuned as more historical information (such as that found in the historical data module 110 of FIG. 1) is fed back. Gamma is based on a weight and a quality of outcome assessed by stakeholders in the environment, e.g., in the case of the table 200, the educator's boss/school would be the stakeholder in the environment.

At Phase 1, the table 200 utilizes a specialized Phase 1 version of the generic Q-function:

Q(ExpertiseLevel, AssignNextLevel)=R(ExpertiseLevel, AssignNextLevel)+Gamma*Max[Q(NextExpLevel, {Summation of all possible rewarding actions(EL) from current state})]

At Phase 2, the table 200 utilizes a specialized Phase 1 version of the generic Q-function:

Q(CurrSkilL, AssignSkilL)=R (CurrSkilL, AssignSkilL)+Gamma*Max[Q(NextHighRtdSklSet, {Summation of all possible rewarding actions(SklSet) from current state})]

At Phase 3, the table 200 utilizes a specialized Phase 3 version of the generic Q-function:

(DesSklSet, AssgnRecSklLevel)=R(DesSklSet, AssgnRecSklLevel)+Gamma*Max[Q(NextRecPrtzdSklLevel, {Summation of all possible rewarding actions(PrtzdSklLvl) from current state})]

Each of the Q-functions can be utilized to determine an action at each phase. For instance, at phase 1, the specialized Phase 1 Q-function incorporates the environment of the user, in this case an educator, with the educator's quantitative and qualitative data as found from profile data and/or evaluations form SMEs, the classroom etc. The Phase 1 Q-function then determines from the environment the level of expertise of the educator and assigns that level to the user. The Phase 1 Q-function then determines a reward for the educator progressing to a higher level of expertise, in this case the educator's reward for moving up one level is 100 and a policy determines an augment/weight to the reward if the educator moves up two levels. In some embodiments, a decrease in level can result in a decrease in reward.

In some embodiments, the Phase 2 and Phase 3 Q-functions utilize the observations/outputs of their subsequent phases as input observations, and at Phase 3 a proposal is generated that is tailored for the educator. It is noted in table 200 that Phase 2 and Phase 3 are missing a reward, this is because only Phase 1 needs to determine the relative number of level increases needed by the educator to become proficient in a given field, and further because the reward from Phase 1 is inherently incorporated into the functions of Phase 2 and Phase 3 by the observations of Phase 1 being incorporated into Phase 2 and transitively Phase 1's observations are inherently incorporated into Phase 3 by Phase 3 incorporating Phase 2′s observations.

It is further noted in table 200 that Phase 3 lacks a policy, this is because Phase 3 generates a proposal for the educator and has determined the most tailored proposal for the educator and that no more skills are needed to be evaluated (e.g., unless and until an addendum indicating a failure in a proposal is identified).

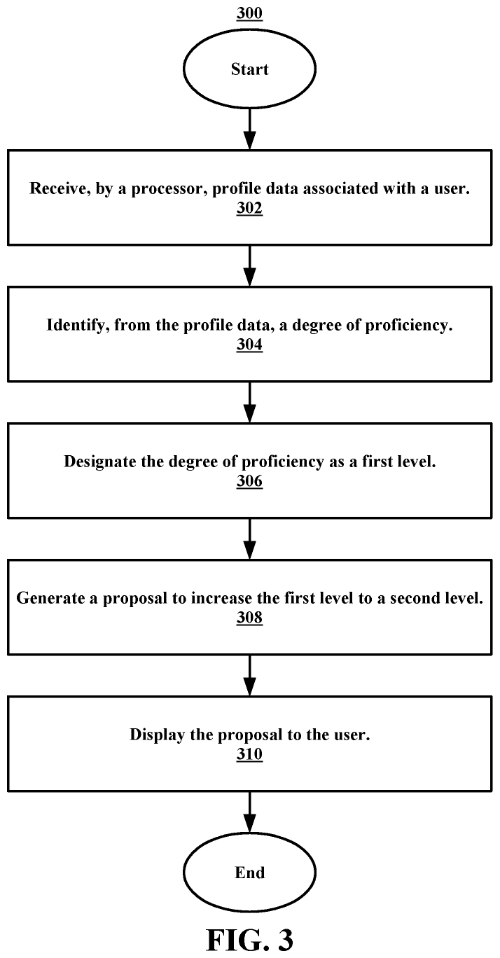

Referring now to FIG. 3, illustrated is a flowchart of an example method 300 for generating a proposal to display to a user, in accordance with embodiments of the present disclosure. In some embodiments, the method 300 is performed by a system and/or a processor in a system. In some embodiments, the method 300 begins at operation 302.

At operation 302, the processor receives profile data associated with a user. The method 300 proceeds to operation 304 where the processor identifies, from the profile data, a degree of proficiency. The degree of proficiency indicates an ability of the user to relay specific information to another user (e.g., individual, trainee, etc.).

The method 300 proceeds to operation 306. At operation 306, the processor designates the degree of proficiency as a first level (e.g., level of expertise). The method 300 proceeds to operation 308 where the processor generates a proposal to increase a user from the first level to a second level. The increase indicates an increase in the degree of proficiency.

The method 300 proceeds to operation 308, where the processor displays the proposal to the user. In some embodiments, after operation 308, the method 300 ends.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

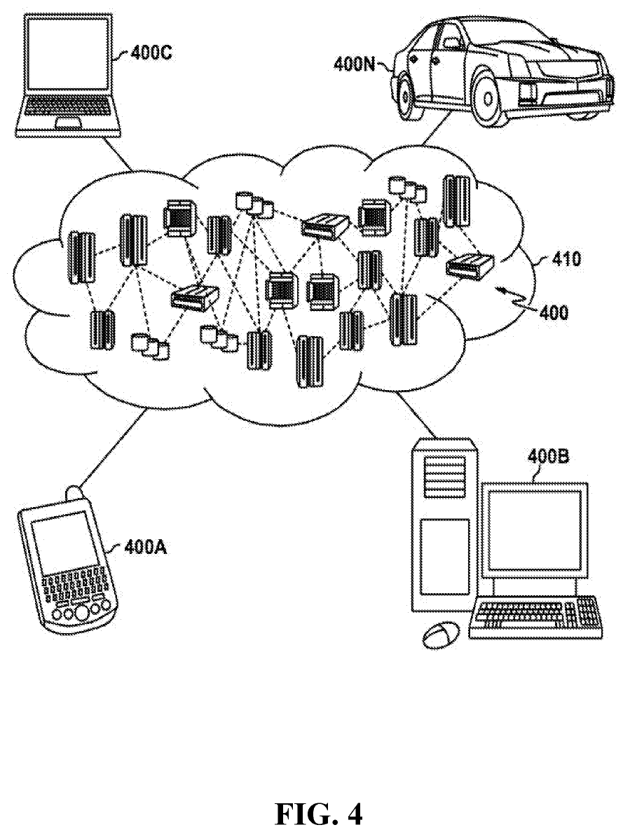

Referring now to FIG. 4, illustrative cloud computing environment 410 is depicted. As shown, cloud computing environment 410 includes one or more cloud computing nodes 400 with which local computing devices used by cloud consumers, such as, for example, personal digital assistant (PDA) or cellular telephone 400A, desktop computer 400B, laptop computer 400C, and/or automobile computer system 400N may communicate. Nodes 400 may communicate with one another. They may be grouped (not shown) physically or virtually, in one or more networks, such as Private, Community, Public, or Hybrid clouds as described hereinabove, or a combination thereof.

This allows cloud computing environment 410 to offer infrastructure, platforms and/or software as services for which a cloud consumer does not need to maintain resources on a local computing device. It is understood that the types of computing devices 400A-N shown in FIG. 4 are intended to be illustrative only and that computing nodes 400 and cloud computing environment 410 can communicate with any type of computerized device over any type of network and/or network addressable connection (e.g., using a web browser).

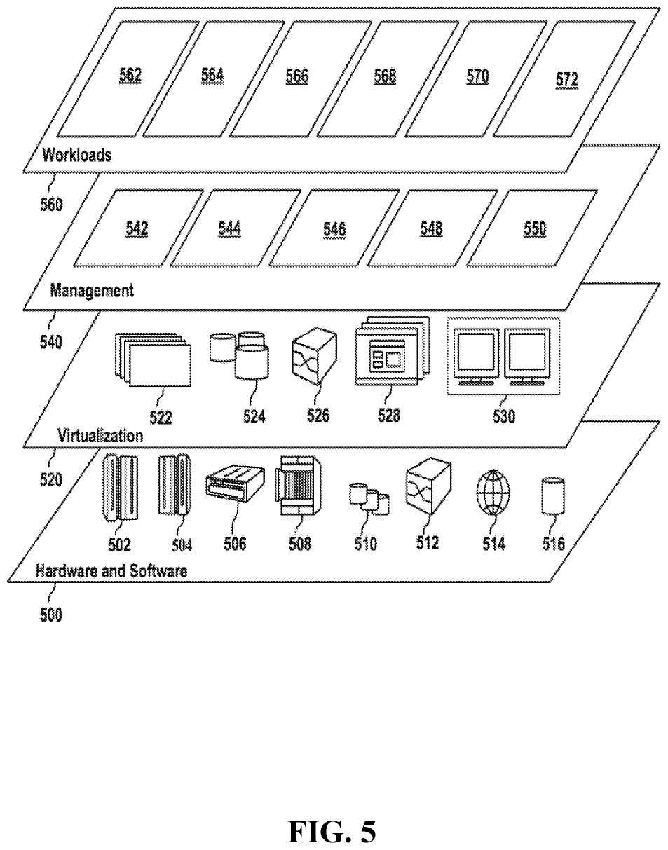

Referring now to FIG. 5, a set of functional abstraction layers provided by cloud computing environment 410 (FIG. 4) is shown. It should be understood in advance that the components, layers, and functions shown in FIG. 5 are intended to be illustrative only and embodiments of the disclosure are not limited thereto. As depicted below, the following layers and corresponding functions are provided.

Hardware and software layer 500 includes hardware and software components. Examples of hardware components include: mainframes 502; RISC (Reduced Instruction Set Computer) architecture based servers 504; servers 506; blade servers 508; storage devices 510; and networks and networking components 512. In some embodiments, software components include network application server software 514 and database software 516.

Virtualization layer 520 provides an abstraction layer from which the following examples of virtual entities may be provided: virtual servers 522; virtual storage 524; virtual networks 526, including virtual private networks; virtual applications and operating systems 528; and virtual clients 530.

In one example, management layer 540 may provide the functions described below. Resource provisioning 542 provides dynamic procurement of computing resources and other resources that are utilized to perform tasks within the cloud computing environment. Metering and Pricing 544 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 546 provides access to the cloud computing environment for consumers and system administrators. Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment may be utilized. Examples of workloads and functions which may be provided from this layer include: mapping and navigation 562; software development and lifecycle management 564; virtual classroom education delivery 566; data analytics processing 568; transaction processing 570; and Q-functioning/Reinforced Learning 572.

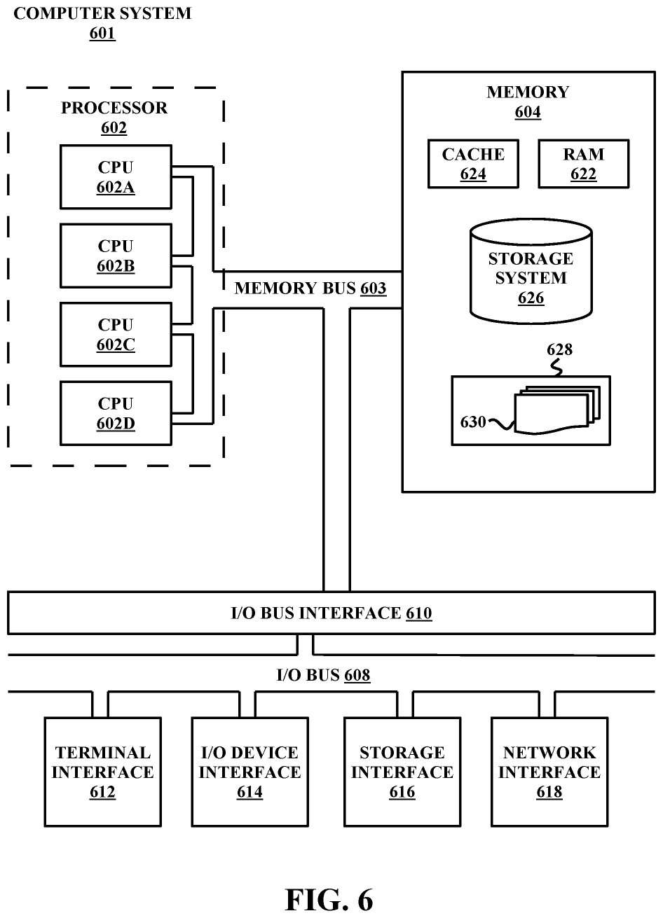

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.”

Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both.

Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smartphone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the

“C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method comprising:
receiving, by a processor, profile data associated with a user;
identifying, from the profile data, a degree of proficiency of the user, wherein the degree of proficiency indicates an ability of the user to relay specific information to a second user;
designating the degree of proficiency as a first level;
generating a proposal to increase the first level to a second level, wherein the increase indicates an increase in the degree of proficiency; and
displaying the proposal to the user.

2. The method of claim 1, wherein the degree of proficiency is measured on a scale, and wherein the scale includes qualitative factors and quantitative factors set by an outside entity.

3. The method of claim 2, further comprising:
analyzing the profile data in regard to the qualitative factors and quantitative factors; and
identifying a number of qualitative factors and quantitative factors that appear in the profile data.

4. The method of claim 1, wherein generating the proposal comprises:
generating one or more proposals;
identifying a degree of success for each of the one or more proposals;
ranking, based on the degree of success, the one or more proposals; and
identifying that the proposal is ranked above each of the other proposals.

5. The method of claim 4, wherein identifying the degree of success for each of the one or more proposals comprises:
weighting each of the one or more proposals based on the profile data and the degree of proficiency; and
determining, from the weighing, which of the one or more proposals increase the first level to the second level.

6. The method of claim 5, further comprising:
weighting each of the one or more proposals with historical data, wherein the historical data is associated with one or more users that are identified as having a shared trait with the user, wherein the shared trait is identified from the profile data; and
selecting the proposal to display to the user, wherein the proposal is selected for being a personalized match for the user.

7. The method of claim 1, further comprising:
receiving an addendum set of profile data associated with the user, wherein the addendum indicates if the first level increased to the second level;
utilizing the addendum to refine the one or more proposals; and
displaying a second proposal to the user.

8. A system comprising:
a memory; and
a processor in communication with the memory, the processor executing instructions contained within the memory in order to perform operations comprising:
receiving profile data associated with a user;
identifying, from the profile data, a degree of proficiency of the user, wherein the degree of proficiency indicates an ability of the user to relay specific information to a second user;
designating the degree of proficiency as a first level;
generating a proposal to increase the first level to a second level, wherein the increase indicates an increase in the degree of proficiency; and
displaying the proposal to the user.

9. The system of claim 8, wherein the degree of proficiency is measured on a scale, and wherein the scale includes qualitative factors and quantitative factors set by an outside entity.

10. The system of claim 9, wherein the operations further comprise:
analyzing the profile data in regard to the qualitative factors and quantitative factors; and
identifying a number of qualitative factors and quantitative factors that appear in the profile data.

11. The system of claim 8, wherein generating the proposal comprises:
generating one or more proposals;
identifying a degree of success for each of the one or more proposals;
ranking, based on the degree of success, the one or more proposals; and
identifying that the proposal is ranked above each of the other proposals.

12. The system of claim 11, wherein identifying the degree of success for each of the one or more proposals comprises:
weighting each of the one or more proposals based on the profile data and the degree of proficiency; and
determining, from the weighing, which of the one or more proposals increase the first level to the second level.

13. The system of claim 12, wherein the operations further comprise:
weighting each of the one or more proposals with historical data, wherein the historical data is associated with one or more users that are identified as having a shared trait with the user, wherein the shared trait is identified from the profile data; and
selecting the proposal to display to the user, wherein the proposal is selected for being a personalized match for the user.

14. The system of claim 8, wherein the operations further comprise:
receiving an addendum set of profile data associated with the user, wherein the addendum indicates if the first level increased to the second level;
utilizing the addendum to refine the one or more proposals; and
displaying a second proposal to the user.

15. A computer program product comprising a computer readable storage medium having program instructions embodied therewith, the program instructions executable by a processor to cause the processor to perform a method, the method comprising:
receiving profile data associated with a user;
identifying, from the profile data, a degree of proficiency of the user, wherein the degree of proficiency indicates an ability of the user to relay specific information to a second user;
designating the degree of proficiency as a first level;
generating a proposal to increase the first level to a second level, wherein the increase indicates an increase in the degree of proficiency; and
displaying the proposal to the user.

16. The computer program product of claim 15, wherein the degree of proficiency is measured on a scale, and wherein the scale includes qualitative factors and quantitative factors set by an outside entity.

17. The computer program product of claim 16, further comprising:
analyzing the profile data in regard to the qualitative factors and quantitative factors; and
identifying a number of qualitative factors and quantitative factors that appear in the profile data.

18. The computer program product of claim 15, wherein generating the proposal comprises:
generating one or more proposals;
identifying a degree of success for each of the one or more proposals;
ranking, based on the degree of success, the one or more proposals; and
identifying that the proposal is ranked above each of the other proposals.

19. The computer program product of claim 18, wherein identifying the degree of success for each of the one or more proposals comprises:
weighting each of the one or more proposals based on the profile data and the degree of proficiency; and
determining, from the weighing, which of the one or more proposals increase the first level to the second level.

20. The computer program product of claim 19, further comprising:
weighting each of the one or more proposals with historical data, wherein the historical data is associated with one or more users that are identified as having a shared trait with the user, wherein the shared trait is identified from the profile data; and
selecting the proposal to display to the user, wherein the proposal is selected for being a personalized match for the user.
